(19) United States
(12) Patent Application Publication
(10) Pub. No.: US 2026/0309686 A1
(43) Pub. Date: Oct. 8, 2026

(54) METHOD FOR PREPARING MODIFIED LIGANDS FOR DETECTING IONS

(71) Applicant: VULCAN PHOTONICS SDN. BHD., Kuala Lumpur (MY)

(72) Inventors: Farah Hidayah Binti JAMALUDIN, Johor Bahru (MY); Khong Nee KOO, Ayer Itam (MY); Evianie Bingak EDWARD, Johor Bahru (MY); Mun Oon FONG, Bayan Lepas (MY)

(21) Appl. No.: 19/482,076

(22) PCT Filed: Jun. 2, 2023
(86) PCT No.: PCT/MY2023/050046

§ 371 Date: Nov. 6, 2025

(51) Int. Cl. G01N 30/95

(52) U.S. Cl. CPC G01N 30/95

(57) ABSTRACT

A method for preparing modified ligands to detect multiple ions in a sample comprising: reacting a plurality of ligands with at least one organic compound to create modified ligands selective to multiple ions; treating the modified ligands with a polar solvent; depositing said modified ligands on a porous substrate; wherein the organic compound comprises at least one organic molecule backbone with one or more alcohol, carboxylic acid or amine groups, and the modified ligands are able to bind with targeted ions in the sample to form ion complexes with varying molecule weights and polarities, and the interactions between the formed ion complexes with the porous substrate results in the separation of the ion complexes enabling the detection of the targeted ions in the sample, through the use of suitable light source and imaging device or spectrometer.

### CROSS-REFERENCE TO RELATED APPLICATIONS

The present application is a filing under 35 U.S.C. 371 as the National Stage of International Application No. PCT/MY2023/050046, filed Jun. 2, 2023, entitled “METHOD FOR PREPARING MODIFIED LIGANDS FOR DETECTING IONS,” which is incorporated herein by reference in its entirety for all purposes.

### FIELD OF INVENTION

The present invention generally relates to sensing and detection of ions, and more particularly to a method of preparing modified ligands for sensing and detecting multiple ions in a sample.

### BACKGROUND

Ion sensing plays an integral role in the management of water and the environment, a range of industrial activities (such as agriculture and food processing), and healthcare (for instance to determine the concentrations of electrolytes present in blood). For samples containing multiple ions, detection normally require a pre-treatment step to remove interferences from dominant ions especially in the case of spectrophotometric and potentiometric methods and/or a separation step in the case of chromatographic methods. Using classical or conventional methods to detect multiple ions in a sample often requires a long time and sometimes requires the use of hazardous analytical reagents. As such, chromatographic analyses are usually favoured when separation of the ions allow for noise/interference free analysis of the ions of interest, as they eliminate sample preparation time and allow simultaneous determination of many anions or cations of interest during a single pass.

For chromatographic analysis, samples are typically sent to laboratories where bulky chromatography system with a charge detector is used to sense the ions after they are separated across a specialized column. This conventional process of sample analysis could pose some problems in situations such as for applications where laboratories with such equipment are not accessible, high cost of analysis and in the event of medical emergencies, where analysis needs to be carried out rapidly.

Hence, there is a need for affordable and rapid method for the simultaneous detection of multiple ions that is less susceptible to interference from other ions.

### SUMMARY

In one aspect, the present invention provides a method for preparing modified ligands for detecting multiple ions in a sample comprising: reacting a plurality of ligands with at least one organic compound to create modified ligands selective to multiple ions; dissolving the modified ligands with a polar solvent; depositing said modified ligands on a porous substrate; wherein the organic compound comprises at least one organic molecule backbone with one or more alcohol, carboxylic acid or amine groups; wherein the modified ligands are able to bind with targeted ions in the sample to form ion complexes with varying molecule weights and polarities, and the interactions between the formed ion complexes with the porous substrate results in the separation of the ion complexes thereby enabling the detection of the targeted ions in the sample.

In an embodiment, the ligands are selected from a variety of molecules containing functional groups such as alcohol, carboxylic acid, amine or hydrophilic acid groups that interact with the porous substrate.

In a further embodiment, one or more of the following organic molecule backbones are selected to react with the ligands containing amine groups and/or ligands containing alcohol groups;
i) Malic acid
ii) Succinic acid
iii) Glutaric acid
iv) Oxalic acid
v) Tannic acid
vi) Polyacrylic acid

In yet a further embodiment, one or more of the following amino-containing ligands are selected for detecting the indicated ions:
i) 4′-Aminobenzo-15-crown 5-Ether for Cadmium ions (Cd)
ii) 4′-Aminobenzo-18-crown 6-Ether or Iron and 4-Amino-6-hydroxy-2-mercaptopyrimidine monohydrate for Potassium ions (K)
iii) 4′-Aminobenzo-24-crown-8 for Caesium ions (Cs)
iv) 1,4,10,13-Tetraoxa-7,16-diazacyclooctadecane for Lead ions (Pb)
v) N,N′-Dibenzyl-4,13-diaza-18-crown 6-Ether for Lead ions (Pb)
vi) Aza 15-crown-5 for Lead ions (Pb)
vii) Iron and 4-Aminobenzo-18-crown-6 complex for Arsenic ions (As)
viii) Iron and 4-Amino-6-hydroxy-2-mercaptopyrimidine monohydrate for Arsenic ions (As)
ix) 4,7,13,16,21,24-Hexaoxa-1,10-diazabicyclo[8.8.8]hexacosane for Radium ions (Ra)
x) 5,6-Benzo-4,7,13,16,21,24-hexaoxa-1,10-diazabicyclo[8.8.8]hexacos-5-ene for Radium ions (Ra)

In another embodiment, one or more of the following alcohol-containing ligands are selected for detecting the indicated ions:
i) Iron and 7-Dihydroxy-1,10-phenanthroline for Arsenic ions (As)
ii) Iron and 4-Amino-6-hydroxy-2-mercaptopyrimidine monohydrate for Arsenic ions (As)

In an embodiment, one or more of the following organic molecule backbones are selected to react with one or more of the ligands containing carboxylic acid groups:
i) Ethylene glycol
ii) Propylene glycol
iii) Xylitol
iv) Erythritol
v) Sorbitol
vi) Polyvinyl alcohol
vii) Polyethylenimine

In a further embodiment, the following carboxylic acid group-containing ligands are selected for detecting the indicated ions:
i) Iron and 3-mercaptopropanoic acid for Arsenic ions (As)
ii) 4′-Carboxybenzo-18-crown 6-Ether for Potassium ions (K)
iii) EDTA for Lead (Pb), Cadmium (Cd) and/or Copper (Cu) ions
iv) Copper EDTA complex for Fluorine ions (F)
v) 4-carboxybenzo-15-crown-5 for Cadmium ions (Cd)
vi) Iron and 4-carboxybenzo-18-crown-6 complex for Arsenic ions (As)
vii) Iron and di-carboxy phenanthroline complex for Arsenic ions (As)

In yet a further embodiment, multiple modified ligands are deposited on the porous substrate to detect multiple ions simultaneously.

In an embodiment, reacting the ligand with an organic compound comprises reaction via amine conjugation or esterification or both.

In a further embodiment, reacting a ligand with an organic compound comprises reaction via amine conjugation at a temperature ranging between 4-30° C. in the presence of 1-Ethyl-3-(3-diemethylaminopropyl)-carbodiimide) (EDC) and N-hydroxysuccinimide (NHS).

In yet a further embodiment, reacting a ligand selective to a targeted ion with an organic compound comprises esterification reaction at a temperature ranging between 60-80° C. in the presence of tin (II) chloride catalyst.

In an embodiment, the porous substrate is a chromatographic strip or plate.

In a further embodiment, the detection of the ions includes by way of chromatographic separation, in which the varying molecular weights of the formed ion complexes enables the chromatographic separation and subsequently detecting the ions.

In yet a further embodiment, the detection of ions includes visualising the ligands and their respective ion complexes that are represented by dots on the substrate under UV light using a detector comprising an ultraviolet (UV) imaging device. Typically, visualizing the ligands includes using a scanner comprising a UV light source and a spectrometer to detect the light reflected or transmitted along the length of the substrate.

In another aspect, the present invention provides a method for sensing multiple ions in a sample, comprising the steps of: providing a porous substrate comprising modified ligands; contacting the sample with the modified ligands to form ion complexes; wherein when the modified ligand comprises at least one functional group to react with an organic compound comprising at least one organic molecule backbone with one or more amine, alcohol or carboxylic acid groups; wherein the modified ligands are able to bind with targeted ions in the sample to form ion complexes with varying molecule weights and polarities, and the interactions between the formed ion complexes with the porous substrate results in the separation of the ion complexes thereby enabling the detection of the targeted ions in the sample.

In an embodiment, the porous substrate includes a chromatographic strip or plate.

In a further embodiment, the detection of the ions includes by way of chromatographic separation, in which the varying molecular weights of the formed ion complexes enables the chromatographic separation and subsequently detecting the ions.

In yet a further embodiment, the detection of ions includes visualising the ligands and their respective ion complexes that are represented by dots on the substrate under UV light using a detector comprising an ultraviolet (UV) imaging device. Typically, visualizing the ligands and their respective ion complexes that are represented by dots on the substrate includes using a scanner comprising a UV light source and a spectrometer to detect the light reflected or transmitted along the length of the substrate.

In an embodiment, the method further comprises the step of identifying the ligands comprising:
calibrating the porous substrate with deionized water to separate the ligands;
determining the location of ligands and its corresponding ion complexes.

In further aspect, the present invention provides a sensor for detecting multiple ions in a sample, the sensor comprising ligands deposited on a porous substrate, such that when the modified ligands are in contact with ions in the sample, ion complexes are formed; wherein the ligands are modified with an organic compound with one or more functional group selected from amine, alcohol and carboxylic acid; wherein the ion complexes molecules having varying molecular weights and polarities, and reaction with the porous substrate result to chromatographic separation on the porous substrate.

### BRIEF DESCRIPTION OF DRAWINGS

The invention will be more understood by reference to the description below taken in conjunction with the accompanying drawings herein:

FIG. 1 provides a schematic diagram of the reaction mechanism in synthesizing the modified ligands in accordance with an embodiment of the present invention;

FIG. 2A provides an example of chromatographic separation of single unmodified ligand and its complex;

FIG. 2B provides an example of chromatographic separation of multiple unmodified ligands and their complexes; and

FIG. 2C provides an example of chromatographic separation of multiple modified ligands and their complexes, in accordance with an embodiment of the present invention.

FIG. 2D and FIG. 2E provide an example of visual detection of separated ligand and its complex using FIG. 2D fluorescent chromatographic plate and a digital camera, or FIG. 2E a normal chromatographic plate and a UV digital camera.

FIG. 2F and FIG. 2G provide an example of the detection of separated ligand and its complex by positioning a light source and spectrometer to detect FIG. 2F the reflectance intensity or FIG. 2G or transmittance intensity along the length of the chromatographic plate.

### DETAILED DESCRIPTION

In line with the above summary, the following description of a number of specific and alternative embodiments is provided to understand the inventive features of the present invention. It shall be apparent to one skilled in the art, however that this invention may be practiced without such specific details. Some of the details may not be described at length so as not to obscure the invention. For ease of reference, common reference numerals will be used throughout the figures when referring to the same or similar features common to the figures.

Embodiments of the invention are described by way of illustration. As will be realized, the invention is capable of other and different embodiments and its several details are capable of modifications in various respects, all without departing from the scope of the present invention. Standard equipment or components may have not been illustrated since they are known in the art.

The present invention provides a method of preparing modified ligands for detecting ions in a sample, in which multiple ions can be detected in the sample simultaneously, comprising a ligand modified with a variety of organic compounds containing a variation of functional groups such as carboxylic acid, amine or alcohol, or a combination thereof. The method for forming the detector comprises the steps of reacting a ligand with an organic compound comprising at least one functional group, to create a modified ligand selective to a targeted ion; treating the modified ligand with a polar solvent and depositing said modified ligand on a porous substrate. When the modified ligand is in contact with the targeted ion in the sample, the modified ligand binds with the targeted ion to form an ion complex, and the interactions between the modified ligand and the formed ion complex with the porous substrate results in the separation of the ion complex from the modified ligand thereby enabling the detection of the targeted ion in the sample.

The porous substrate provides a surface that allows chromatographic separation of the modified ligands and their formed ion complexes. The substrate therefore provides a stationary phase platform for the chromatographic separation and may be formed from materials selected from a group comprising silica (SiO₂) or cellulose. An example of the porous substrate is a chromatographic strip or plate. Accordingly, detection of intensity of the separated lines or dots on the chromatographic strip or plate correspond to the concentration of the modified ligands and their complexes.

The ligands may be selected from a variation of functional groups such as alcohol, carboxylic acid and amine groups or hydrophilic acid groups that interacts with the porous substrate. Typically, the ligands are selected to cater for different ions, ranging from less ion specific ethylenediaminetetraacetic acid, EDTA, (for cadmium and lead ions) to more ion specific crown ethers (such as 15-crown-5 for cadmium, aza 15-crown-5 for lead, 18-crown-6 for potassium, 24-crown-8 for Caesium, and, 4,7,13,16,21,24-Hexaoxa-1,10-diazabicyclo[8.8.8]hexacosane and 5,6-Benzo-4,7,13, 16,21,24-hexaoxa-1,10-diazabicyclo[8.8.8]hexacos-5-ene for Radium) and complexes (such as 3-mercaptopropanoic acid-ferric iron complex for arsenic and EDTA-copper complex for fluoride). The organic compound can be a monomer, an oligomer or polymer, to provide an organic molecule backbone for the selected functional groups. Examples of monomer, oligomer and polymer backbone, functional groups and ligands for different ions are provided in TABLE 1.

TABLE 1
List of Monomer, Oligomer and Polymer backbone, Functional
groups and Ligands Based on Targeted Ions

| | | Organic | | Ion(s) |
|---|---|---|---|---|
| | | molecule | | of |
| | Ligands | backbone | Reaction | interest |
| Ligand | 4′-Aminobenzo-15-crown | Malic acid | Amine | Cd |
| containing | 5-Ether | | conjugation | |
| amine | 4′-Aminobenzo-18-crown | Succinic acid | | K |
| groups | 6-Ether | | | |
| | 4′-Aminobenzo-24-crown-8 | Glutaric acid | | Cs |
| | 1,4,10,13-Tetraoxa-7,16- | Oxalic acid | | Pb |
| | diazacyclooctadecane | | | |
| | N,N′-Dibenzyl-4,13- | Tannic acid | | |
| | diaza-18-crown 6-Ether | | | |
| | aza 15-crown-5 | Poly acrylic acid | | |
| | Iron and | — | | As |
| | 4-Aminobenzo-18-crown-6 | | | |
| | complex | | | |
| | Iron and 4-Amino- | — | | |
| | 6-hydroxy-2- | | | |
| | mercaptopyrimidine | | | |
| | monohydrate | | | |
| | 4,7,13,16,21,24-Hexaoxa- | — | | Ra |
| | 1,10- | | | |
| | diazabicyclo[8.8.8]hexacosane | | | |
| | 5,6-Benzo-4,7,13,16,21,24- | — | | |
| | hexaoxa-1,10- | | | |
| | diazabicyclo[8.8.8]hexacos- | | | |
| | 5-ene | | | |
| Ligand | Iron and 7-Dihydroxy-1,10- | Malic acid | Fischer | As |
| containing | phenanthroline | | esterification | |
| alcohol | Iron and 4-Amino-6-hydroxy- | Succinic acid | | |
| groups | 2-mercaptopyrimidine | | | |
| | monohydrate | | | |
| | — | Glutaric acid | | |
| | — | Oxalic acid | | |
| | — | Tannic acid | | |
| | — | Poly acrylic acid | | |
| Ligand | Iron and | Ethylene glycol | Fischer | As |
| containing | 3-mercaptopropanoic acid | | esterification | |
| carboxylic | 4′-Carboxybenzo-18-crown | Propylene glycol | | K |
| acid groups | 6-Ether | | | |
| | EDTA | Xylitol | | Pb, Cd, |
| | | | | Cu |
| | Copper EDTA complex | Erythritol | | F |
| | 4-carboxybenzo-15-crown-5 | Sorbitol | | Cd |
| | Iron and | Polyvinyl alcohol | | As |
| | 4-carboxybenzo-18-crown-6 | | | |
| | complex | | | |
| | Iron and di-carboxy | Polyethylenimine | Amine | As |
| | phenanthroline | | conjugation | |
| | complex | | | |

Reacting the ligands with organic compounds comprising containing varying organic molecule backbones with one or more alcohol, carboxylic acid or amine groups enable the different ligands and the formed ion complexes separate with reasonable resolution and therefore observed using a detector. The number and type of functional groups on the ligands, molecular weight of the ligands and complexes allow for varying interaction with the porous substrate.

Accordingly, the selection of organic compounds is based on the ligands' functional groups. For example, ligands containing amine groups can be reacted with monomer, oligomers and polymers backbone containing carboxylic acid groups via an amine conjugation reaction at a temperature of 4-30° C. in the presence of 1-Ethyl-3-(3-dimethylaminopropyl)-carbodiimide), EDC, and N-Hydroxysuccinimide, NHS. Ligands containing carboxylic acid groups can react with monomer, oligomers and polymers backbone containing carboxylic acid groups via Fischer esterification reaction at a temperature of 60-80° C. in the presence of a tin (II) chloride catalyst. While ligands containing carboxylic acid groups can be reacted with monomer, oligomers and polymers backbone containing both carboxylic acid groups or amine groups via Fischer esterification reaction at a temperature of 60-80° C. in the presence of a tin (II) chloride catalyst, or amine conjugation reaction at a temperature of 4-30° C. in the presence of EDC, and NHS, respectively.

Next, the modified ligands selective towards the ions of interest are selected and dissolved in a volatile polar solvent. The mixture can then be deposited on the substrate and dried at a temperature no higher than 40° C. The amount deposited can be tuned to an amount larger than the range of ion concentrations tested.

In use, the following sequence may be observed when testing a sample solution. First, an amount of the solution containing the ions is dropped onto the porous substrate deposited with the modified ligands. The reaction between ligands and the ions in the sample results to the formation of ion complexes with varying molecular weights and polarities. The ligands and the complexes then separate based on their interaction with the porous substrate. Detection of the separated compound can be done visually if the substrate contains fluorescent material; and compounds appear as dark dots on the substrate when exposed to a light source, for instance ultraviolet light (UV).

The darker the intensity of the dot the higher its concentration. As part of the detection process, the location of the separated ligands on the substrate can be obtained by separating the ligands using deionized water, leaving the additional dots or spots corresponding to the ligands' respective complex. A digital camera may be provided to enable visual detection of the dots. The detection techniques may vary based on the chromatographic plates used. For instance, for a normal chromatographic plate, to detect the dots, an ultraviolet (UV) imaging device is required in order to view the non-coloured ligands, which normally appear as dark dots. For chromatographic plates with fluorescent material embedded therein, a UV light source is used to illuminate the plate hence enable the dark dots to be viewed. Alternatively, a scanner consisting of a UV light source and a spectrometer can be used to detect the light reflected or transmitted along the length of the chromatographic plate. If there are any UV absorbing ligand or complex, said ligand absorbs UV light and the reflected and transmitted UV intensity is reduced.

The sensitivity and detection range can be tuned by changing the ligand loading deposited on the porous substrate.

The present invention further provides an ion sensor comprising modified ligands deposited on a porous substrate, wherein ion complexes are formed when the modified ligands are in contact with the targeted ions. The varying molecular weights and polarity affects the interaction of the ligands and complexes with the porous substrate resulting in the separation of the ligands and complexes which are represented by dark dots or spots on the porous substrate under the right lighting and detection condition. The separation therefore enables the detection of ions in the sample.

The present invention enables simultaneous separation of different ligands and its complexes, therefore simultaneous multiple ions sensing. Further, modifying the ligands with polar organic molecules or varying sizes allow the replacement of expensive specialised column with normal silica or cellulose porous substrates while maintaining the same resolution of separation with respect to the strength of the interaction between the modified ligands and its complexes with the porous substrates.

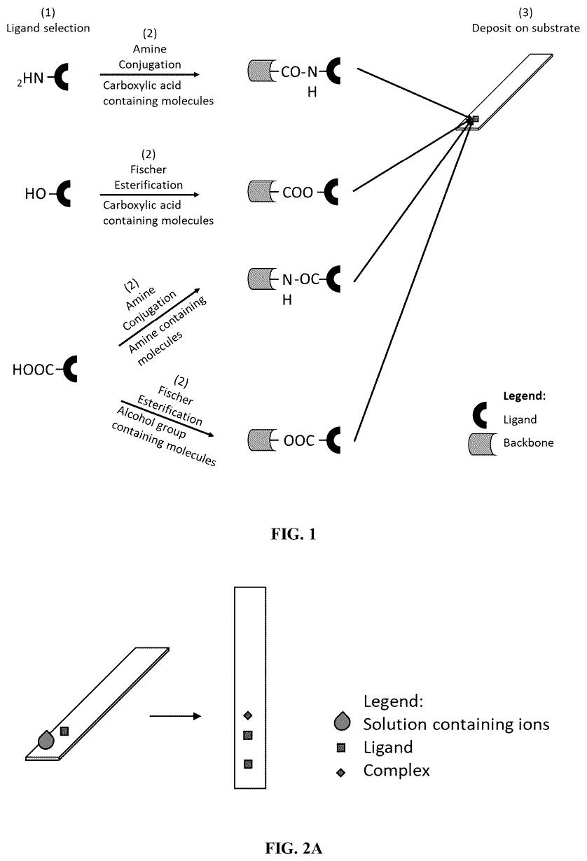

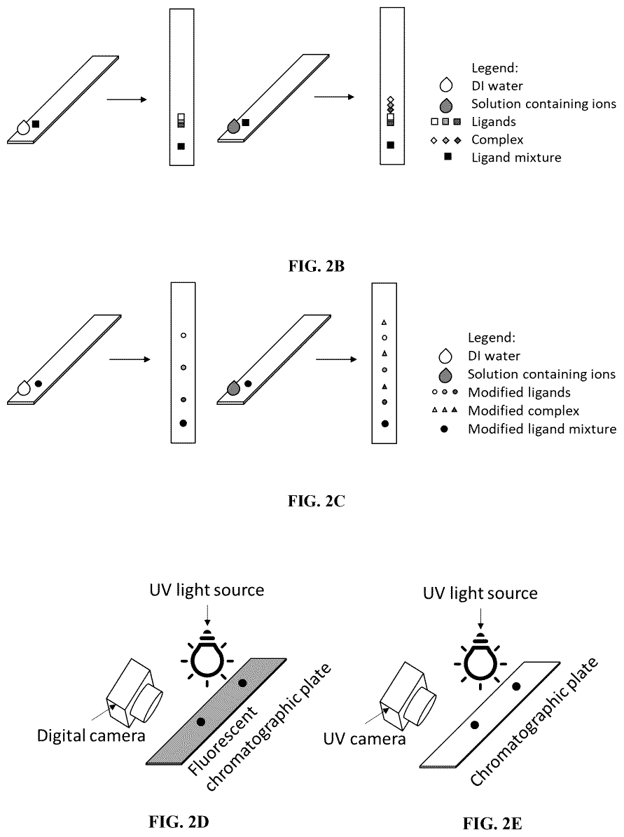

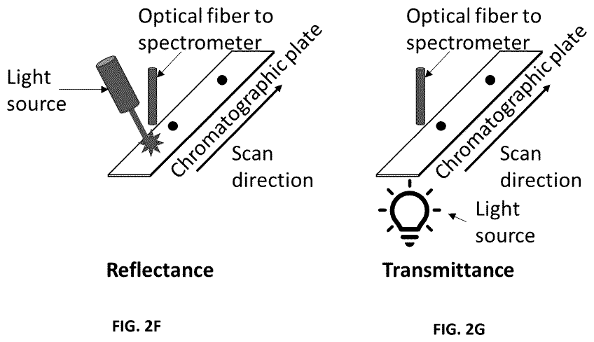

An example of the reaction mechanism to synthesize the modified ligands is shown in FIG. 1. Examples of separation result using unmodified single ligand, unmodified multiple ligands and modified multiple ligands to detect ions on a porous substrate are shown in FIG. 2A, FIG. 2B and FIG. 2C respectively, while examples of visual detection are shown in FIGS. 2D-2G.

The use of ligands selective to the ions of interest allows chromatographic separation to be carried out with less interference from other ions. Further, modifying ligands with polar organic molecules or varying sizes in accordance with the present invention allows the replacement of expensive specialized columns or equipment of the like, while maintaining the desired resolution of separation with respect to the strength of the interaction between the modified ligands and the complexes with the porous substrate.

The organic compounds as the reactants can be dissolved in environmentally safe solvents such as water, ethanol, isopropanol and acetonitrile. In contrast to conventional methods, simultaneous separation of ligands and their complexes can be done to sense different ions without the use of bulky and expensive equipment.

While the invention has been described as required in terms in preferred embodiments and specific operating ranges and conditions, those skilled in the art will appreciate that the invention described herein is susceptible to variations and modifications other than those specifically described.

1. A method for preparing modified ligands for detecting multiple different ions in a sample comprising:
reacting a plurality of ligands with at least one organic compound to create modified ligands selective to multiple ions;
dissolving the modified ligands with a polar solvent;
depositing said modified ligands on a porous substrate;
wherein the organic compound comprises at least one organic molecule backbone with one or more alcohol, carboxylic acid or amine groups;
wherein the porous substrate provides a stationary phase platform; and
wherein the modified ligands are able to bind with multiple different targeted ions in the sample to form ion complexes with varying molecule weights and polarities, and the interactions between the formed ion complexes with the porous substrate results in the chromatographic separation of the ion complexes thereby enabling simultaneous detection of the multiple different targeted ions in the sample.

2. The method according to claim 1, wherein the ligands are selected from a variety of molecules containing functional groups such as alcohol, carboxylic acid, amine or hydrophilic acid groups that interact with the porous substrate.

3. The method according to claim 2, wherein one or more of the following organic molecule backbones are selected to react with the ligands containing amine groups and/or ligands containing alcohol groups:
i) Malic acid
ii) Succinic acid
iii) Glutaric acid
iv) Oxalic acid
v) Tannic acid
vi) Polyacrylic acid.

4. The method according to claim 2, wherein the following amino-containing ligands are selected for detecting the indicated ions:
i) 4′-Aminobenzo-15-crown 5-Ether for Cadmium ions (Cd)
ii) 4′-Aminobenzo-18-crown 6-Ether or Iron and 4-Amino-6-hydroxy-2-mercaptopyrimidine monohydrate for Potassium ions (K)
iii) 4′-Aminobenzo-24-crown-8 for Caesium ions (Cs)
iv) 1,4,10,13-Tetraoxa-7,16-diazacyclooctadecane for Lead ions (Pb)
v) N,N′-Dibenzyl-4, 13-diaza-18-crown 6-Ether for Lead ions (Pb)
vi) Aza 15-crown-5 for Lead ions (Pb)
vii) Iron and 4-Aminobenzo-18-crown-6 complex for Arsenic ions (As)
viii) Iron and 4-Amino-6-hydroxy-2-mercaptopyrimidine monohydrate for Arsenic ions (As)
ix) 4,7,13,16,21,24-Hexaoxa-1,10-diazabicyclo[8.8.8]hexacosane for Radium ions (Ra)
x) 5,6-Benzo-4,7,13,16,21,24-hexaoxa-1,10-diazabicyclo[8.8.8]hexacos-5-ene for Radium ions (Ra).

5. The method according to claim 2, wherein one or more of the following alcohol-containing ligands are selected for detecting the indicated ions:
i) Iron and 7-Dihydroxy-1, 10-phenanthroline for Arsenic ions (As)
ii) Iron and 4-Amino-6-hydroxy-2-mercaptopyrimidine monohydrate for Arsenic ions (As).

6. The method according to claim 2, wherein one or more of the following organic molecule backbones are selected to react with one or more of the ligands containing carboxylic acid groups:
i) Ethylene glycol
ii) Propylene glycol
iii) Xylitol
iv) Erythritol
v) Sorbitol
vi) Polyvinyl alcohol
vii) Polyethylenimine.

7. The method according to claim 6, wherein the following carboxylic acid group-containing ligands are selected for detecting the indicated ions:
i) Iron and 3-mercaptopropanoic acid for Arsenic ions (As)
ii) 4′-Carboxybenzo-18-crown 6-Ether for Potassium ions (K)
iii) EDTA for Lead (Pb), Cadmium (Cd) and/or Copper (Cu) ions
iv) Copper EDTA complex for Fluorine ions (F)
v) 4-carboxybenzo-15-crown-5 for Cadmium ions (Cd)
vi) Iron and 4-carboxybenzo-18-crown-6 complex for Arsenic ions (As)
vii) Iron and di-carboxy phenanthroline complex for Arsenic ions (As).

8. (canceled)

9. The method according to claim 1, wherein reacting a ligand with an organic compound comprises reaction via amine conjugation or esterification or both.

10. The method according to claim 1, wherein reacting a ligand with an organic compound comprises reaction via amine conjugation at a temperature ranging between 4-30° C. in the presence of 1-Ethyl-3-(3-diemethylaminopropyl)-carbodiimide) (EDC) and N-hydroxysuccinimide (NHS).

11. The method according to claim 1, wherein reacting a ligand selective to a targeted ion with an organic compound comprises esterification reaction at a temperature ranging between 60-80° C. in the presence of tin (II) chloride catalyst.

12. The method according to claim 1, wherein the porous substrate is a chromatographic strip or plate.

13. The method according to claim 1, wherein detection of the ions includes by way of chromatographic separation, in which the varying molecular weights of the formed ion complexes enables the chromatographic separation and subsequently detecting the ions.

14. The method according to claim 13, wherein detection of ions includes visualising the ligands and their respective ion complexes that are represented by dots on the substrate under UV light using a detector comprising an ultraviolet (UV) imaging device.

15. The method according to claim 14, wherein visualizing the ligands and their respective ion complexes that are represented by dots on the substrate includes using a scanner comprising a UV light source and a spectrometer to detect the light reflected or transmitted along the length of the substrate.

16. A method for sensing multiple different targeted ions in a sample, comprising the steps of:
providing a porous substrate as a stationary phase platform comprising modified ligands;
contacting the sample with the modified ligands to form ion complexes;
wherein when the modified ligand comprises at least one functional group to react with an organic compound comprising at least one organic molecule backbone with one or more amine, alcohol or carboxylic acid groups;
wherein the modified ligands are able to bind with targeted ions in the sample to form ion complexes with varying molecule weights and polarities, and the interactions between the formed ion complexes with the porous substrate results in chromatographic the separation of the ion complexes thereby enabling simultaneous detection of the multiple different targeted ions in the sample.

17. The method for sensing ions in a sample according to claim 16,
wherein the porous substrate includes a chromatographic strip or plate.

18. The method for sensing ions in a sample according to claim 16 wherein the varying molecular weights and polarity of the formed ion complex enables chromatographic separation and subsequently detecting the ion.

19. The method for sensing ions in a sample according to claim 16 wherein the ligands and their complexes are represented by dark spots on the porous substrate under varying lighting and detector conditions.

20. The method for sensing ions in a sample according to claim 18 wherein the separation can be visualized under UV light and a UV imaging device.

21. The method for sensing ions in a sample according to claim 16, wherein the method further comprises the step of identifying the ligands comprising:
calibrating the porous substrate with deionized water to separate the ligands;
determining the location of ligands and its corresponding ion complexes.

22. A sensor for detecting multiple different targeted ions in a sample, the sensor comprising ligands deposited on a porous substrate, such that when the modified ligands are in contact with ions in the sample, ion complexes are formed;
wherein the ligands are modified with an organic compound with one or more functional group selected from amine, alcohol and carboxylic acid;
wherein the ion complexes molecules having varying molecular weights and polarities, and reaction with the porous substrate result to chromatographic separation on the porous substrate.
